(19) United States
(12) Patent Application Publication
(10) Pub. No.: US 2026/0286914 A1
(43) Pub. Date: Sep. 24, 2026

(54) METHOD FOR DETECTING TUNING MEASURES ON AN INTERNAL COMBUSTION ENGINE, COMPUTER PROGRAM PRODUCT, AND CONTROL UNIT

(71) Applicant: Robert Bosch GmbH, Stuttgart (DE)

(72) Inventors: Daniel Heitz, Rutesheim (DE); Florian Hoffmann, Ludwigsburg (DE); Ralph Kober, Markgroeningen (DE); Stefan Stein, Stuttgart (DE)

(21) Appl. No.: 19/568,320

(22) Filed: Mar. 16, 2026

(30) Foreign Application Priority Data
Mar. 18, 2025 (DE) 10 2025 110 330.5

(51) Int. Cl. F02D 41/38; F02D 41/14; F02D 41/26

(52) U.S. Cl. CPC F02D 41/3836; F02D 41/1402; F02D 41/26; F02D 2200/0602

(57) ABSTRACT

A method for detecting tuning measures on an internal combustion engine. In the method, a first actual curve of a first quantity is recorded or ascertained depending on a reference quantity, and a second actual curve of at least one second quantity is recorded or ascertained depending on the reference quantity. A first target curve of the first quantity is provided depending on the reference quantity. A second target curve of the at least one second quantity is provided depending on the reference quantity. A tuning measure influencing the reference quantity is inferred if both the first actual curve deviates from the first target curve and the second actual curve deviates from the second target curve.

### FIELD

The present disclosure relates to a method for detecting tuning measures on an internal combustion engine, a computer program product, and a control unit.

BACKGROUND INFORMATION By intervening in certain parameters, for example for the metering of the amount of fuel to be injected, the mass of fuel entering the combustion chambers of an internal combustion engine can be influenced. Such interventions are used, for example, by tuners to increase engine performance. However, this can lead to an overload of components of both an injection system and the internal combustion engine itself. This can also increase fuel consumption and worsen exhaust emissions.

According to a proposed law, tuning measures that impair the conformity of the behavior of the internal combustion engine should be detected and ultimately prevented. A method for detecting tuning measures is described in Germany Patent Application No. DE 10 2013 212 223 A1.

### SUMMARY

A problem underlying the present disclosure is solved by a method, and by a computer program product and a control unit having the features of the present disclosure. Developments of the subject matter are disclosed herein.

The present disclosure allows for reliable detection and, if necessary, also evaluation of a suspicion of tuning measures (manipulative intervention, as a subset of the “tampering” referred to in the EU7 draft legislation) on an internal combustion engine, purely via a software function, i.e. without the need for additional hardware components. According to the EU7 draft legislation, “tampering” refers to any type of modification that results in a vehicle no longer complying with legal requirements. The present disclosure thus contributes to keeping at bay damage to the internal combustion engine and preventing deliberate deteriorations in fuel consumption and emission characteristics, without incurring significant additional costs. The basis for this is that the actual behavior of at least two different quantities, both dependent on the same reference quantity, is compared with an expected behavior. These quantities are typically sensor values or adaptation values of control functions. An evaluation therefore takes place as to whether conspicuous behavior occurs in the same direction and simultaneously on different paths that, however, depend on the same reference quantity.

Specifically, this is achieved by a method for detecting tuning measures on an internal combustion engine. Such tuning measures are typically carried out in order to increase the performance of the internal combustion engine compared to its factory condition. In the method according to an example embodiment of the present disclosure, a first actual curve of a first quantity is recorded or ascertained depending on a reference quantity. The reference quantity is typically not time, but rather the quantity that is primarily affected by the tuning measure. The term “curve” does not necessarily refer to a more or less continuous recording or ascertaining. Rather, the curve can also be represented by a plurality of discrete pairs of values. In this process, in most cases the minimum should be four to five pairs of values.

Furthermore, in the method according to the present disclosure a second actual curve of at least a second quantity-which is not the first quantity-is recorded or ascertained depending on the reference quantity, what has been said above regarding the “curve” also applying here. Preferably, pairs of values are recorded or ascertained for the same values of the reference quantity as for the first quantity. It is particularly preferred if a plurality of different second quantities are recorded or ascertained depending on the reference quantity, as this further increases the reliability of the method according to the present disclosure.

The first and second quantities can, for example, be values recorded by sensors or parameters provided by software adaptation functions or detection functions.

According to the present disclosure, a first and typically continuous target curve of the first quantity is also provided depending on the reference quantity, and a second and typically continuous target curve of the at least one second quantity is provided depending on the reference quantity. Preferably, a plurality of target curves of a plurality of different second quantities is provided. If both the first actual curve typically only from a certain value of the reference quantity deviates from the first target curve, and the second actual curve-again typically only from the certain value of the reference quantity-deviates from the second target curve, a tuning measure influencing or manipulating the reference quantity-possibly only from the certain value of the reference quantity-is inferred.

It is important that the identified deviations can be physically meaningfully related to the manipulation of the reference quantity. Therefore, a tuning measure influencing the reference quantity should be inferred only if the identified deviations do not contradict each other, for example with regard to the direction of manipulation (increase or decrease of the reference quantity). Rather, the deviations should be in the same direction in the truest sense of the word, and should occur simultaneously.

The comparison is typically automated using appropriate software programs, and a tuning measure is typically inferred only if the deviation exceeds a certain level and/or if the deviation extends over a certain value range of the reference quantity. However, it is also conceivable in principle that the curves could be displayed on a screen, for example, and that a person skilled in the art could then assess the displayed curves.

In a development, it is provided that the reference quantity is a rail pressure recorded by a common rail pressure sensor, “rail pressure” not necessarily having to be the physical quantity with the unit [hPa] or [bar], but rather also being able to be another quantity (for example the sensor signal with the unit [mV] ) that characterizes the rail pressure. This is based on the following considerations: in internal combustion engines with a common rail injection system, tuning measures that lead to an increased rail pressure are a measure, particularly well-known because of its simplicity, to thereby increase the amount of fuel injected during an injection and consequently the power of the internal combustion engine. However, the increased rail pressure leads to various problems. For example, the fuel injectors are subjected to higher loads and can therefore wear out faster. Furthermore, the increased amount of fuel alters the emission characteristics, so that emissions can reach impermissible levels. The use of the fuel pressure in the common rail, i.e. the “rail pressure”, as a reference quantity is therefore a promising measure in many cases for detecting impermissible tuning measures.

For increasing the power of the internal combustion engine, the tuning measure typically manipulates the rail pressure signal only in high engine power ranges, and leaves it unchanged in low and medium engine power ranges. This then leads to the fact that the actual curves relevant for this tuning measure only begin to deviate from the target curves from a certain value of the reference quantity, which is an additional plausibility criterion. In this case, a tuning measure influencing the rail pressure is therefore inferred only if the actual curves relevant to the rail pressure all begin to deviate from the target curves at approximately the same rail pressure.

Increasing the rail pressure affects numerous components of the internal combustion engine, in particular the fuel injectors. Parameters specific to the fuel injectors, such as the signal amplitude of a needle closing sensor, therefore react in the same way (in the same direction and simultaneously) for all fuel injectors. Injector-specific quantities, such as fuel injector leakage, multiply according to the number of fuel injectors. In contrast, system-specific properties, such as the compression modulus of the fuel, react across the entire system.

A development of this provides that the first quantity is one from the following group: pressure in a valve chamber of a first fuel injector; injection duration of a first fuel injector; opening delay of a first fuel injector; reversal of movement of a nozzle needle of a first fuel injector; opening duration of a servo valve of a first fuel injector; opening delay of a servo valve of a first fuel injector; control of an actuator of a first fuel injector; detected degree of coking of a first fuel injector; fuel compressibility; system leakage; control parameter of a variable throttle for a fuel pump; fuel viscosity; fuel density; delivery parameter of a fuel pump.

Some of the above-mentioned quantities can be recorded in a very simple manner by means of a piezoelectric sensor typically installed in a fuel injector, the so-called “needle closing sensor” or NCS, or derived from the signal thereof. This is typically installed in a valve chamber of a fuel injector. It is relatively sensitive and records a fuel pressure in this valve chamber. By means of the NCS signal it is possible, for example, to detect when a fuel injector nozzle needle closes, when a fuel injector servo valve opens and closes, etc. A system leakage can, in turn, be ascertained for example by evaluating the rail pressure curve during a phase in which a fuel pump is not currently delivering fuel to the common rail and no fuel injector is currently drawing fuel from the common rail. Fuel compressibility can be ascertained from the curve of the pressure build-up in the common rail, i.e. when the fuel pump is delivering fuel into the common rail, but no fuel is being drawn from the common rail by the fuel injectors. Furthermore, some of the above-mentioned quantities can be ascertained, for example, using a neural network. Furthermore, it is understood that the above quantities do not necessarily have to be the actual physical quantities themselves, but rather can also be quantities that characterize these.

A development of this provides that the at least one second quantity is different from the first quantity and is one from the following group: pressure in a valve chamber of a second fuel injector; injection duration of a second fuel injector; opening delay of a second fuel injector; reversal of movement of a nozzle needle of a second fuel injector; opening duration of a servo valve of a second fuel injector; opening delay of a servo valve of a second fuel injector; control of an actuator of a second fuel injector; detected degree of coking of a second fuel injector; fuel compressibility; system leakage; control parameter of a variable throttle for a fuel pump; fuel viscosity; fuel density; delivery parameter of a fuel pump. It is understood here too that the above quantities do not necessarily have to be the actual physical quantities themselves, but rather can also be quantities that characterize these.

In a particularly preferred variant, the first quantity is a pressure in the valve chamber of a first fuel injector ascertained via the NCS, and the second quantities are the pressures in the valve chambers of all other fuel injectors ascertained via the corresponding NCSs. In a further particularly preferred variant, the second quantities also include the fuel compressibility and the system leakage.

In a development, it is provided that the first quantity and/or the second quantity are standardized for different values of the reference quantity with respective expected values, and the deviations of the standardized values from the value 1 are compared with respective limit values. The standardization increases the resolution by taking tolerances into account, thereby simplifying processing and increasing procedural accuracy.

In a development, it is provided that the first quantity and/or the second quantity, for different values of the reference quantity in an operating range of the internal combustion engine in which a tuning measure is active, is compared with the respective conditions in an operating range of the internal combustion engine in which no tuning measure is active.

In a development, it is provided that if a tuning measure is inferred, an entry is made in an error memory. In this way, for example, the tuning measure can be detected during a visit to a workshop.

In a development, it is provided that the entry in an error memory contains at least one of the following pieces of information: reference quantity; type and magnitude of the deviations of the optionally standardized values from the expected values; suspicion probability. The type of tuning measure can be inferred based on the reference quantity. The type and magnitude of the deviations allow for an evaluation of the scope of the tuning measure. A suspicion probability can be calculated based on the number of second quantities for which a “suspicious” actual curve has been identified.

The present disclosure also relates to a computer program product comprising commands that, when the program is executed by a computer, cause said computer to execute the method of the above type.

Furthermore, the present disclosure relates to a control unit for open-loop and/or closed-loop control of the operation of an internal combustion engine, comprising at least one processor, at least one memory, and at least one computer program product of the above type stored in the memory.

Overall, the present disclosure can also be described as follows: many quantities that can be recorded or ascertained during the operation of an internal combustion engine depend predictably on a common reference quantity in normal operation, in which no malfunctions are present and no manipulations have been carried out by tuning measures. If the reference quantity changes, these quantities therefore behave in a predictable way, i.e. have so-called “standard behavior”. In this case, the quantities typically change in a continuous manner depending on the reference quantity. These quantities can be both recorded or ascertained physical quantities and adaptation quantities or control parameters.

Said standard behavior is, for example, stored in software within a control unit of the internal combustion engine. The approach according to the present disclosure states that a suspicion of manipulation by a tuning measure is strengthened all the more if a plurality of quantities behave in a similar way (simultaneously and in the same direction) in a manner deviating from the predicted or expected manner. The behavior is observed by comparing the actual behavior of individual sensor and/or adaptation values with a stored expected target behavior and simultaneously evaluating whether any conspicuous behavior, i.e., for example a deviation that is simultaneous and in the same direction, arises in a plurality of the quantities.

A possible example embodiment of the present disclosure will be explained below with reference to the figures.

### BRIEF DESCRIPTION OF THE DRAWINGS

FIG. 1 is a schematic view of an internal combustion engine with a common rail system and with, by way of example, four cylinders and respective fuel injectors.

FIG. 2 shows five graphs in which typical continuous and steady curves (“standard behavior”) of a needle closing sensor signal amplitude (NCS) of a fuel injector, a fuel compressibility, a system leakage and an injection duration of a fuel injector are each plotted against a rail pressure.

FIG. 3 shows five graphs similar to that of FIG. 2, but based on pairs of values at specific rail pressures and in the case of the NCS signal amplitude and the injection duration for the four fuel injectors.

FIG. 4 shows five graphs similar to that of FIG. 3, but not for typical curves (standard behavior), but rather for deviating curves in the case of a tuning measure influencing the rail pressure from a certain rail pressure.

FIG. 5 shows five graphs similar to FIG. 3, the quantities shown being standardized with respective expected values.

FIG. 6 shows five graphs similar to FIG. 4, the quantities shown being standardized with respective expected values.

FIG. 7 is a flowchart of a method for detecting tuning measures on the internal combustion engine of FIG. 1, according to an example embodiment of the present disclosure.

FIG. 8 is a table illustrating a detection logic of a tuning measure, according to an example embodiment of the present disclosure.

FIG. 9 is a table illustrating a further detection logic of a tuning measure, according to an example embodiment of the present disclosure.

### DETAILED DESCRIPTION OF EXAMPLE EMBODIMENTS

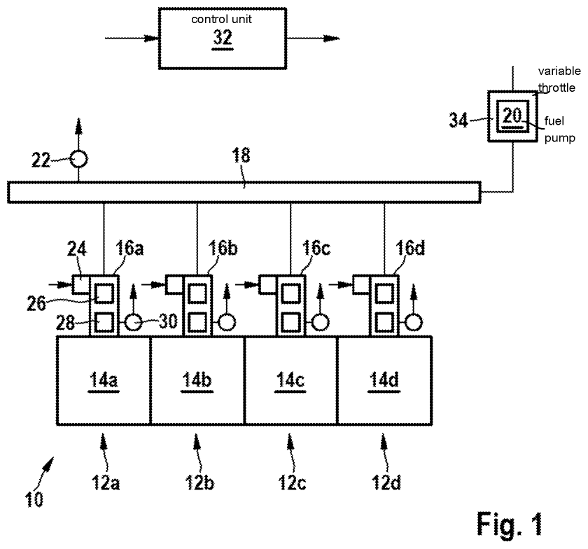

For the sake of simplicity and clarity, not all elements in FIG. 1 are provided with reference signs.

An internal combustion engine is designated overall by reference sign 10 in FIG. 1. In the present case, by way of example, it comprises four cylinders 12a-d with corresponding combustion chambers 14a-d. Fuel enters these directly via respective fuel injectors 16a-d. These are connected to a common rail 18, into which the fuel is delivered by a fuel pump 20. A fuel pressure in the common rail 18 is recorded by a rail pressure sensor 22. This fuel pressure is also referred to as “rail pressure”.

Each fuel injector 16a-d comprises an actuator 24 which acts on a hydraulic servo valve 26 with a valve needle (not shown). This in turn causes a nozzle needle 28 to open and close. When this opens, fuel is injected under high pressure via corresponding outlet nozzles of the fuel injector 16a-d into the combustion chamber 14 assigned to it. Each fuel injector 16a-d comprises a piezoelectric sensor 30 which detects a fuel pressure in a valve chamber (no reference sign) of the fuel injector 16a-d. As will be shown below, different quantities can be ascertained with the aid of the signal of the piezoelectric sensor 30. An important one of these quantities relates to the time of the closing of the nozzle needle 28. Therefore, the piezoelectric sensor 30 is also referred to as the “needle closing sensor” or “NCS” for short.

The operation of the internal combustion engine 10 is controlled by a control unit 32. This receives signals from numerous sensors, i.e. also from the rail pressure sensor 22 and the needle closing sensors 30. The control unit 32 controls numerous actuators, i.e. also the actuators 24 of the fuel injectors 16. A variable throttle 34 for the fuel pump 20 is also controlled by the control unit 32. The throttle 34 sets the amount of fuel delivered to the common rail 18. The control unit 32 comprises at least one processor and at least one memory, as well as at least one computer program product stored in the memory, which are not shown. The computer program product in turn includes commands which, when the program is executed by a computer, for example the processor, cause said computer to execute various methods for operating the internal combustion engine 10, including the method for detecting a tuning measure, described below.

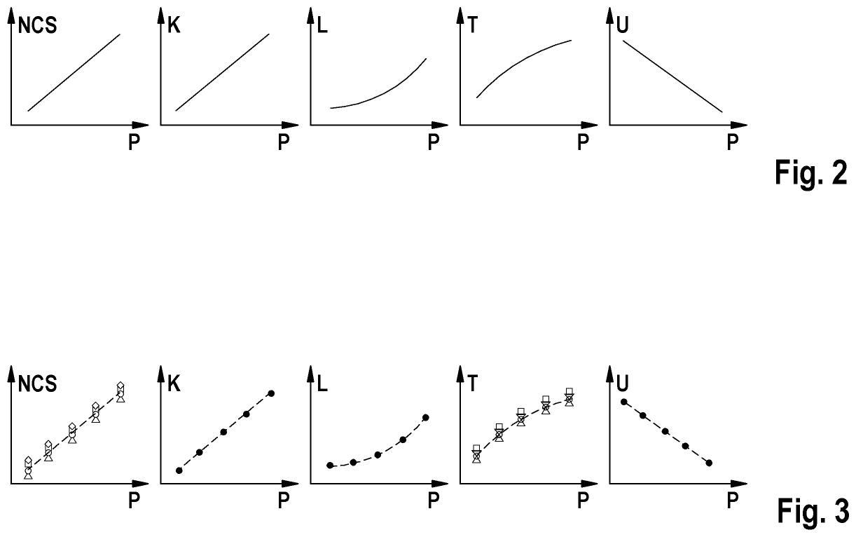

FIG. 2-6 each show five graphs. The abscissa of all graphs is the rail pressure p detected by the rail pressure sensor 22. The ordinate of those graphs that are on the far left in the figures is a signal NCS of the needle closing sensor 30 representing the fuel pressure in the valve chamber of a fuel injector 16a-d. The ordinate of those graphs that are the second from the left in the figures is a compression modulus K of the fuel in the common rail 18 and in the fuel injectors 16a-d. This is ascertained using the curve of the signal from the rail pressure sensor 22 when the fuel pump 20 is delivering fuel to the common rail 18, but the fuel injectors 16a-d are not currently drawing any fuel from the common rail 18.

The ordinate of those graphs that are the third from the right in the figures is a leakage L of the fuel from the common rail 18. This is ascertained from the curve of the signal of the rail pressure sensor 22 which is present when the fuel pump 20 is not delivering fuel to the common rail 18 and the fuel injectors 16 are not drawing any fuel from the common rail 18. The ordinate of those graphs that are the second from the right in the figures is an injection duration T of the fuel injectors 16. This is also ascertained from the signal of the respective needle closing sensor 30. The ordinate of those graphs that are on the far right in the figures is a control parameter U of the throttle 34. The control parameter U is, for example, a current supply that is ascertained on the basis of the control unit, e.g. of an output stage (not shown).

FIG. 2 shows the continuous curves under ideal conditions. These are therefore in this respect “ideal curves” or “target curves” representing normal behavior. It can be seen that the signal NCS increases linearly with respect to the rail pressure p. The same applies to the compression modulus K. In contrast, the leakage L increases approximately parabolically with respect to the rail pressure p, with an increasing slope towards the end. This characteristic is typical for certain types of fuel injectors with solenoid valve actuators. In an embodiment that is not shown, the fuel injectors have a different design, and these fuel injectors exhibit a leakage behavior with a decreasing tendency with respect to the rail pressure. Fuel injectors without leakage also exist, in which the characteristic is therefore less suitable for detecting tampering. The injection duration T, in turn, increases approximately parabolically with respect to the rail pressure p, but with a decreasing slope towards the end. The current supply U of the throttle 34 decreases linearly with increasing rail pressure p.

In FIG. 3 the actual curves of the respective quantities NCS, K, L and T recorded or ascertained during the operation of the internal combustion engine 10 are approximated with respect to the rail pressure p by, in the present case, by way of example, five discrete pairs of values at five selected rail pressures, the values of the rail pressures being selected, in the present case, by way of example, such that they are approximately equidistant in magnitude. However, this is not a mandatory requirement for the method described here. It can also be seen that the signal NCS and the injection duration T are specified for each of the four fuel injectors 16a-d. The signal NCS and the injection duration T of the fuel injector 16a are symbolized by a diamond. The signal NCS of the fuel injector 16a represents a first quantity. The five corresponding diamonds in the leftmost graph of FIG. 3 thus correspond to a first actual curve of this first quantity, which depends on a reference quantity, namely the rail pressure p. The signals NCS of the other fuel injectors 16b-d, the compression modulus K, the leakage L, the injection duration T of the fuel injectors 16a-d, and the current supply U of the throttle 34 represent respective second quantities. Second actual curves of these second quantities, which are also dependent on the aforementioned reference quantity, namely the rail pressure p, are thus approximated by the pairs of values of these second quantities in the respective graphs.

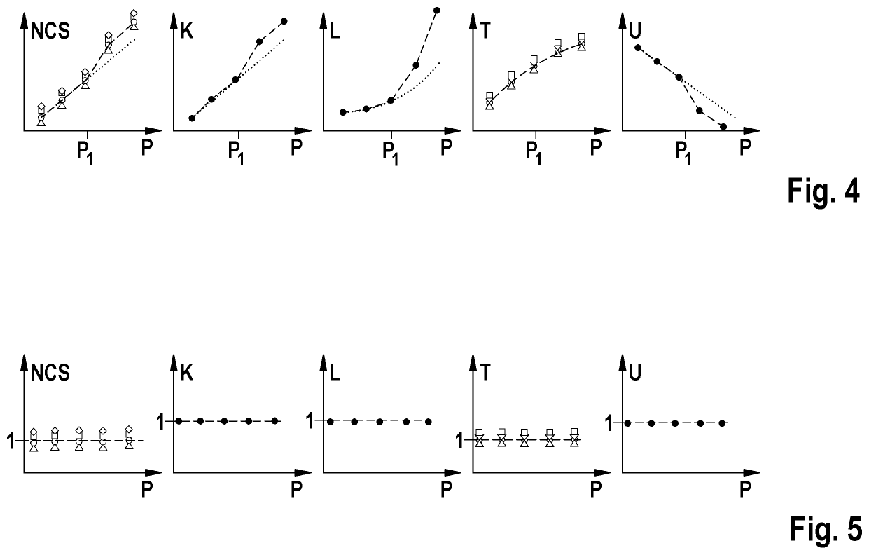

FIG. 3 shows the actual curves for an internal combustion engine 10 in which the signal of the rail pressure sensor 22 was not manipulated. These actual curves therefore largely correspond to the target curves shown as dashed lines in FIG. 3 or to the curves in FIG. 2. In contrast, FIG. 4 shows actual curves for an internal combustion engine 10 in which the signal of the rail pressure sensor 22 was manipulated by a tuning measure. The manipulation is typically carried out by interposing an electronic device (not shown) in a signal line of the rail pressure sensor 22. This electronic device ensures that, above a certain rail pressure p1, the control unit 32 is shown a lower rail pressure p than is actually present in the common rail 18. This causes the control unit 32 to control the throttle 34 in such a way that the amount of fuel delivered by the fuel pump 20 into the common rail 18 is increased, in order to compensate for the supposedly too low rail pressure p. However, this actually leads to an increased rail pressure p compared to the factory condition.

FIG. 4 shows that the actual curves of both the first quantity (NCS signal of the fuel injector 16a) and the actual curves of a plurality of second quantities, namely the NCS signals of the fuel injectors 16b-d, the compression modulus K, the leakage L and the current supply U of the throttle 34, deviate from the respective target curves upward or, for the current supply U downward, (i.e. in the same direction) from the rail pressure p1 (i.e. simultaneously). At the rail pressure p1, the actual curves therefore have a kind of kink or discontinuity. Physically, this is related to the fact that the rail pressure p in the common rail 18, which is increased due to the tuning measure, also affects the pressure in the valve chamber of the fuel injectors 16a-d, which is recorded by the needle closing sensor 30 and expressed in the NCS signal. However, due to the increased rail pressure, the compression modulus K also changes (the fuel is compressed more) and the leakage L increases from the rail pressure p1 in each case. In addition, as has already been explained above, the behavior of the current supply U of the throttle 34 also changes from the rail pressure p1. Only the actual curve of the injection duration T does not change or at least does not change significantly-in the design of the fuel injectors 16 considered here by way of example-compared to the target curve with respect to the rail pressure p, from the rail pressure p1.

Because both the first actual curve deviates from the first target curve and at least one second actual curve deviates from its second target curve, or in the present case, by way of example, a plurality of second actual curves deviate from the respective second target curves, from the specified rail pressure p1, a tuning measure influencing the reference quantity, in the present case the rail pressure p, from the rail pressure p1, can be inferred with high reliability.

It is understood that, in other embodiments that are not shown, other and/or further quantities may be used as first quantities or second quantities. These include: reversal of movement of the nozzle needle of a fuel injector; opening duration of a servo valve of a fuel injector; opening delay of a servo valve of a fuel injector; detected degree of coking of a fuel injector; fuel viscosity; fuel density; delivery parameter of a fuel pump. It is essential that the actual curves of at least two different physical quantities, adaptation quantities, or detection quantities, or of the same quantities but of at least two different components, are compared with the respective target curves using the same reference quantity. With regard to the “degree of coking”, the following should be noted: the addition “detected” refers to the fact that the degree of coking actually present remains unchanged by the tuning measure (rail pressure sensor manipulation). However, the detection method implemented in the control unit 32 reacts to the manipulated rail pressure and “falsely” indicates a changed degree of coking—detecting, as it were, a changed degree of coking, even though the actual degree of coking does not change.

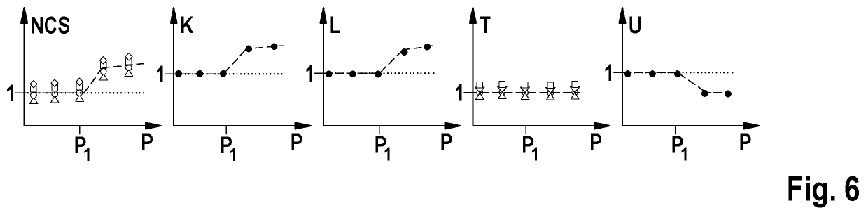

FIGS. 5 and 6 essentially correspond to FIGS. 3 and 4, but the values of the pairs of values of the actual curves are standardized with the pairs of values of the target curves.

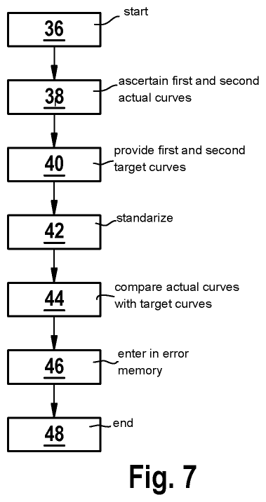

A method for detecting tuning measures is shown as a flowchart in FIG. 7. After a start function block 36, the first and second actual curves described above are ascertained in a function block 38. The first and second target curves described above are provided in a function block 40. This corresponds in principle to FIG. 3 (without tuning) and 4 (with tuning). The standardization described above takes place according to FIG. 5 (without tuning) and 6 (with tuning) in a function block 42. The actual curves are compared with the target curves in a function block 44. If a deviation that is simultaneous and in the same direction is identified, which is greater than a limit value, and this is identified for all first and second quantities that would have to be affected by a tuning that influences the reference quantity, then an entry is made in an error memory in a function block 46. The entry can, for example, contain information about the type of reference quantity that was manipulated by the tuning measure, i.e. in the present case the rail pressure p. Likewise, the entry can contain information about the type and magnitude of the deviations of the actual quantities from the target quantities. Furthermore, the entry may contain information about the probability that a tuning measure is actually present. This probability can be determined, for example, on the basis of the number of second quantities of which the actual curve deviates simultaneously and in the same direction from the target curve. The method ends in an end function block 48.

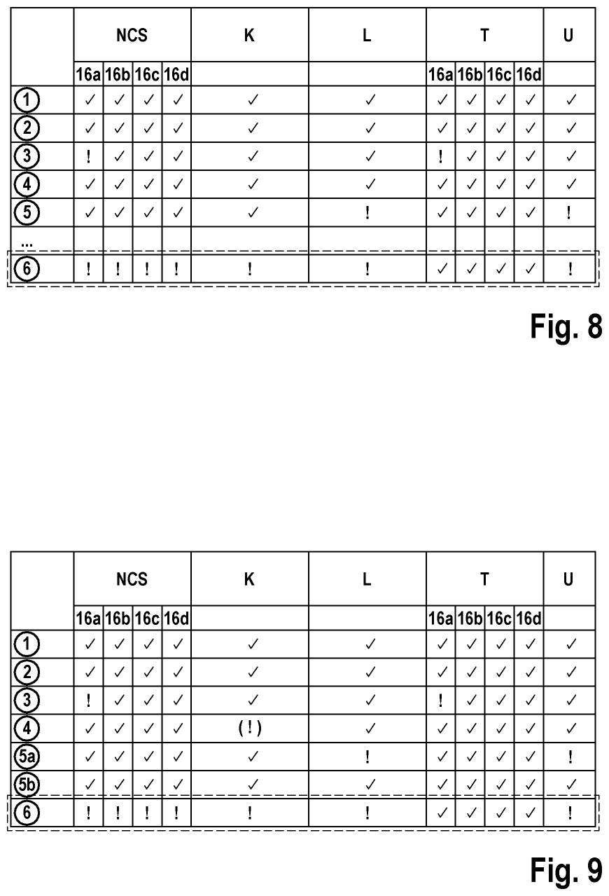

Based on the table in FIG. 8, a detection logic concerning a continuity of the actual curves of the first and second quantities with respect to the rail pressure p is now explained. The individual rows of the table denote possible error states. Row number 1 denotes a normal state, i.e. without errors and without manipulation. Row number 2 denotes a possible error state in which the amount of fuel injected changes due to drift over the lifetime of one of the fuel injectors 16a-d. Row number 3 denotes a possible error state in which a fuel injector 16a-d does not function properly because, for example, a chip is located on an armature plate of an actuator 24 designed as a magnetic actuator. Row number 4 denotes a possible error state in which an impermissible fuel was used. Row number 5 denotes a possible error state in which an impermissible leakage is present. Row number 6 denotes a possible manipulation of the rail pressure sensor 22 by a tuning measure. Fields with an exclamation mark denote an identified discontinuity in the actual curve of the respective quantity or a deviation from the nominal behavior or the target curve. It can be seen that a manipulation of the rail pressure sensor 22 by a tuning measure can be clearly distinguished from other error states due to the plurality of identified deviations that are simultaneous and in the same direction.

The same applies to the table in FIG. 8, from which a detection logic concerning a temporal continuity of the actual curves over a plurality of driving cycles, in the present case, by way of example, two driving cycles, can be seen. In contrast to the table in FIG. 7, row number 5a denotes a sudden leakage, whereas the error state according to number 5b denotes a gradually increasing leakage.

It is understood that the method described above can also be carried out on internal combustion engines with a number of cylinders different from four. It is also understood that the described method can be carried out with a smaller number of evaluated parameters and/or other parameters.

1-10. (canceled)

11. A method for detecting a tuning measure on an internal combustion engine, the method comprising the following steps:
recording or ascertaining a first actual curve of a first quantity, depending on a reference quantity;
recording or ascertaining a second actual curve of at least one second quantity, depending on the reference quantity;
providing a first target curve of the first quantity, depending on the reference quantity;
providing a second target curve of the at least one second quantity, depending on the reference quantity; and
inferring a tuning measure influencing the reference quantity when both the first actual curve deviates from the first target curve and the second actual curve deviates from the second target curve.

12. The method according to claim 11, wherein the reference quantity is a rail pressure recorded by a common rail pressure sensor.

13. The method according to claim 12, wherein the first quantity is one from the following group: pressure in a valve chamber of a first fuel injector, injection duration of the first fuel injector, opening delay of a first fuel injector, reversal of movement of a nozzle needle of the first fuel injector, opening duration of a servo valve of the first fuel injector, opening delay of a servo valve of the first fuel injector, control of an actuator of the first fuel injector, detected degree of coking of the first fuel injector, fuel compressibility, system leakage, control parameter of a variable throttle for a fuel pump, fuel viscosity, fuel density, delivery parameter of the fuel pump.

14. The method according to claim 13, wherein the at least one second quantity is different from the first quantity and is one from the following group: pressure in a valve chamber of a second fuel injector, injection duration of a second fuel injector, opening delay of the second fuel injector, reversal of movement of a nozzle needle of the second fuel injector, opening duration of a servo valve of the second fuel injector, opening delay of a servo valve of the second fuel injector, control of an actuator of the second fuel injector, detected degree of coking of the second fuel injector, fuel compressibility, system leakage, control parameter of a variable throttle for the fuel pump, the fuel viscosity, the fuel density, delivery parameter of the fuel pump.

15. The method according to claim 11, wherein the first quantity and/or the second quantity are standardized to standardized values for different values of the reference quantity with respective expected values and deviations of the standardized values from a value of 1 are compared with respective limit values.

16. The method according to claim 11, wherein the first quantity and/or the second quantity is compared, for different values of the reference quantity in an operating range of the internal combustion engine in which a tuning measure is active, with respective conditions in an operating range of the internal combustion engine in which no tuning measure is active.

17. The method according to claim 11, wherein when the tuning measure is inferred, an entry is made in an error memory.

18. The method according to claim 17, wherein the entry in an error memory includes at least one of the following pieces of information: the reference quantity, type and magnitude of deviations of standardized values of the first quantity and/or the second quantity from expected values, suspicion probability.

19. A non-transitory computer readable medium on which is stored a computer program product including commands for detecting a tuning measure on an internal combustion engine, the commands, when executed by a computer, causing the computer to perform the following steps:
recording or ascertaining a first actual curve of a first quantity, depending on a reference quantity;
recording or ascertaining a second actual curve of at least one second quantity, depending on the reference quantity;
providing a first target curve of the first quantity, depending on the reference quantity;
providing a second target curve of the at least one second quantity, depending on the reference quantity; and
inferring a tuning measure influencing the reference quantity when both the first actual curve deviates from the first target curve and the second actual curve deviates from the second target curve.

20. A control unit for open-loop and/or closed-loop control of an operation of an internal combustion engine, the control unit comprising:
at least one processor;
at least one non-transitory memory on which is stored a computer program product including commands for detecting a tuning measure on an internal combustion engine, the commands, when executed by the at least one processor, causing the at least one processor to perform the following steps:
recording or ascertaining a first actual curve of a first quantity, depending on a reference quantity,
recording or ascertaining a second actual curve of at least one second quantity, depending on the reference quantity,
providing a first target curve of the first quantity, depending on the reference quantity,
providing a second target curve of the at least one second quantity, depending on the reference quantity, and
inferring a tuning measure influencing the reference quantity when both the first actual curve deviates from the first target curve and the second actual curve deviates from the second target curve.
